(19) United States
(12) Patent Application Publication
(10) Pub. No.: US 2024/0141256 A1
(43) Pub. Date: May 2, 2024

(54) Home Care Compositions

(71) Applicant: Colgate-Palmolive Company, New York, NY (US)

(72) Inventor: Earvin REYES, Ocoyoacac (MX)

(21) Appl. No.: 18/498,814

(22) Filed: Oct. 31, 2023

Related U.S. Application Data
(60) Provisional application No. 63/420,750, filed on Oct. 31, 2022.

(51) Int. Cl. C11D 3/00; C11D 3/04; C11D 3/10; C11D 3/12

(52) U.S. Cl. CPC C11D 3/001; C11D 3/046; C11D 3/10; C11D 3/126

(57) ABSTRACT

Fabric compositions, such as fabric conditioner compositions for providing softening benefits to fabric are disclosed herein. In accordance with an aspect of the invention, provided is a fabric conditioner composition that includes from about 20 to about 70 wt. %, based on the total weight of the fabric conditioner composition, of a softening agent comprising a clay; from about 25 to about 70 wt. %, based on the total weight of the fabric conditioner composition, of a filler selected from a metal sulfate, a metal carbonate, and a combination of two or more thereof; and from about 1 to about 15 wt. %, based on the total weight of the fabric conditioner composition, of a polyol.

### CROSS-REFERENCE TO RELATED PATENT APPLICATIONS

This application claims priority to U.S. Appl. No. 63/420,750, titled Home Care Compositions and filed Oct. 31, 2022, the content of which is incorporated herein by reference in its entirety for all purposes.

### BACKGROUND

Presently, laundry softening is most often and practically accomplished during the rinsing step with a liquid softening composition that is separate from the detergent composition or during the drying step. To apply liquid softening composition to the laundry in the washing machine, the liquid softening composition is introduced to the laundry during the rinsing step. The liquid softening composition may be automatically introduced into the rinse from a compartment that keeps the liquid softening composition separate from the washing composition. The compartment may be part of the agitator, if present, or another part of the washing machine that can be opened to dispense the liquid softening composition into the drum.

This is often referred to as softening through the rinse. Softening through the rinse requires the consumer to dose the detergent composition and the softening composition to different locations of the washing machine. Additionally, liquid softening compositions may cause build-up in washing machines.

Some attempts have been made in the art to develop wash cycle active fabric softeners, typically in powder form. These products, however, are characterized by the same inconvenience inherent with the use of powdered detergents, namely, problems of handling, caking in the container or wash cycle dispenser, and the need for a dosing device to deliver the desired amount of active softener material to the wash water.

The use of a unit dose wash cycle fabric softening composition in the form of a compacted granular tablet offers numerous advantages, but it is important that such tablets be sufficiently hard and not friable so as to withstand handling and transportation without breaking or fragmenting. In order to achieve the desired level of hardness, tablet makers generally tend to increase the compacting pressure. But, a high compacting pressure, if favorable to the hardness of the tablet, lowers the disintegration rate of such tablet. The cycle fabric softening composition in the form tablets can also interact with the detergent, thus reducing the effectiveness of the detergent, the fabric softening compositions and/or causing a build-up of residue.

Improved fabric compositions would be desirable.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Aspects of the invention relate to fabric compositions, such as fabric conditioner compositions for providing softening benefits to fabric. The fabric compositions may be adapted for use during drying of the fabric, e.g., during a dry cycle of a clothing dryer. In accordance with an aspect of the invention, provided is a fabric conditioner composition that includes from about 20 to about 70 wt. %, based on the total weight of the fabric conditioner composition, of a softening agent comprising a clay; from about 25 to about 70 wt. %, based on the total weight of the fabric conditioner composition, of a filler selected from a metal sulfate, a metal carbonate, and a combination of two or more thereof; and from about 1 to about 15 wt. %, based on the total weight of the fabric conditioner composition, of a polyol, wherein the fabric conditioner composition has less than about 1 wt. %, based on the total weight of the fabric conditioner composition, of quaternary ammonium compounds. In some embodiments, the fabric composition is in the form of a tablet.

In accordance with another aspect, provided is a fabric conditioner tablet that comprises from about 20 to about 70 wt. %, based on the total weight of the fabric conditioner tablet, of bentonite; a filler selected from a metal sulfate, a metal carbonate, and a combination of two or more thereof; and from about 1 to about 15 wt. %, based on the total weight of the fabric conditioner tablet, of a polyol, wherein the fabric conditioner tablet comprises less than about 3 wt. % of water, based on the total weight of the fabric conditioner tablet.

In accordance with a further aspect, provided is a fabric conditioner composition having from about 20 to about 70 wt. %, based on the total weight of the fabric conditioner composition, of bentonite; a filler selected from a metal sulfate, a metal carbonate, and a combination of two or more thereof; and from about 1 to about 15 wt. %, based on the total weight of the fabric conditioner composition, of a polyol, wherein the fabric conditioner composition is free of softening agents other than bentonite.

### BRIEF DESCRIPTION OF THE DRAWINGS

The features, and advantages of the invention will be apparent from the following more detailed description of certain embodiments of the invention and as illustrated in the accompanying drawings in which:

FIG. 1 is a graph showing the softness of fabric receiving a non-limiting example composition or a comparative composition in accordance with aspects of the invention.

It should be understood that the various aspects are not limited to the compositions, arrangements, and instrumentality shown in the figures.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc.

The term “about” when referring to a number means any number within a range of 10% of the number. For example, the phrase “about 2 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” means percent by weight with respect to the fabric composition. The symbol “°” refers to a degree, such as a temperature degree or a degree of an angle. The symbols “h”, “min”, “mL”, “nm”, and “μm” refer to hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

When referring to chemical structures, and names, the symbols “C”, “H”, and “O” mean carbon, hydrogen, and oxygen, respectively. The symbols “—”, “═” and “≡” mean single bond, double bond, and triple bond, respectively.

“Volatile”, as used herein, means having a flash point of less than about 100° C. “Non-volatile”, as used herein, means having a flash point of greater than about 100° C.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

The phrases, “a mixture thereof,” “a combination thereof,” or a combination of two or more thereof” do not require that the mixture include all of A, B, C, D, E, and F (although all of A, B, C, D, E, and F may be included). Rather, it indicates that a mixture of any two or more of A, B, C, D, E, and F can be included. In other words, it is equivalent to the phrase “one or more elements selected from the group consisting of A, B, C, D, E, F, and a mixture of any two or more of A, B, C, D, E, and F.” Likewise, the term “a salt thereof” also relates to “salts thereof.” Thus, where the disclosure refers to “an element selected from the group consisting of A, B, C, D, E, F, a salt thereof, and a mixture thereof,” it indicates that that one or more of A, B, C, D, and F may be included, one or more of a salt of A, a salt of B, a salt of C, a salt of D, a salt of E, and a salt of F may be included, or a mixture of any two of A, B, C, D, E, F, a salt of A, a salt of B, a salt of C, a salt of D, a salt of E, and a salt of F may be included.

All components and elements positively set forth in this disclosure can be negatively excluded from the claims. In other words, the fabric compositions of the instant disclosure can be free or essentially free of all components and elements positively recited throughout the instant disclosure. In some instances, the fabric compositions of the present disclosure may be substantially free of non-incidental amounts of the ingredient(s) or compound(s) described herein. A non-incidental amount of an ingredient or compound is the amount of that ingredient or compound that is added into the fabric composition by itself. For example, a fabric composition may be substantially free of a non-incidental amount of an ingredient or compound, although such ingredient(s) or compound(s) may be present as part of a raw material that is included as a blend of two or more compounds.

Some of the various categories of components identified may overlap. In such cases where overlap may exist and the fabric composition includes both components (or the composition includes more than two components that overlap), an overlapping compound does not represent more than one component. For example, certain compounds may be characterized as both a lubricant and a glidant. If a particular fabric composition includes both a lubricant and a glidant, a compound that may be characterized as both a lubricant and a glidant will serve only as either a lubricant or a glidant—not both.

For readability purposes, the chemical functional groups are in their adjective form; for each of the adjectives, the word “group” is assumed. For example, the adjective “alkyl” without a noun thereafter, should be read as “an alkyl group”.

Aspects of the invention relate to fabric compositions, such as fabric conditioner compositions for providing softening benefits to fabric. The fabric compositions disclosed herein may be a fabric care compositions and/or a fabric conditioner composition. The inventors discovered that fabric compositions having desirable softening performance can be achieved without using quaternary ammonium compounds by employing certain combinations of ingredients in particular amounts. Additionally, the fabric compositions disclosed herein desirably utilize natural softening agents while providing similar softening performance and fragrance intensity to fabrics as traditional fabric compositions, such as those containing quaternary ammonium compounds.

The fabric compositions disclosed herein may be substantially free or free of quaternary ammonium compounds. For example, the fabric compositions may have less than about 5 wt. %, less than about 4 wt. %, less than about 3 wt. %, less than about 2 wt. %, less than about 1 wt. %, less than about 0.5 wt. %, or less than about 0.1 wt. %, based on the total weight of the fabric composition, of quaternary ammonium compounds. In at least one embodiment, the fabric composition has about 0 wt. % or 0 wt. % of quaternary ammonium compounds, based on the total weight of the fabric composition.

In accordance with an aspect of the invention, provided is a fabric composition that includes from about 20 to about 70 wt. %, based on the total weight of the fabric conditioner composition, of a softening agent comprising a clay; from about 25 to about 70 wt. %, based on the total weight of the fabric conditioner composition, of a filler selected from a metal sulfate, a metal carbonate, and a combination of two or more thereof; and from about 1 to about 15 wt. %, based on the total weight of the fabric conditioner composition, of a polyol, wherein the fabric conditioner composition has less than about 1 wt. %, based on the total weight of the fabric conditioner composition, of quaternary ammonium compounds.

The fabric composition may formulated to be in the form of a tablet. For example, the fabric composition may be in the form of pressed powder tablet or may have a powder core with a shell encapsulating the powder core. The fabric compositions may in some preferred embodiments be formulated for use during drying of a fabric, such as during a dry cycle of a clothing dryer. Thus, at least one aspect of the disclosure is directed to the use of a fabric composition, which may be in the form of a tablet, for during the drying of a fabric, such as during a dry cycle of a clothing dryer.

The fabric composition may have a reduced amount of water, e.g., when the fabric composition is in the form of a powdered tablet. Regardless of the form, in some embodiments, the fabric composition has less than about 5 wt. %, less than about 4 wt. %, less than about 3 wt. %, less than about 2 wt. %, less than about 1 wt. %, less than about 0.5 wt. %, or less than about 0.1 wt. % of water, based on the total weight of the fabric composition. In at least one embodiment, the fabric composition may be substantially free or free of water. For instance, the amount of water present in the fabric compositions may be about 0 wt. % or 0 wt. %, based on the total weight of the fabric composition. In some cases, the fabric composition may have less than about 5 wt. %, less than about 4 wt. %, less than about 3 wt. %, less than about 2 wt. %, less than about 1 wt. %, less than about 0.5 wt. %, less than about 0.1 wt. %, about 0 wt. %, or 0 wt. % of a non-incidental amount of water, based on the total weight of the fabric composition.

In some cases, the fabric composition may achieve the desired performance while having a reduced amount of acid. For instance, the fabric compositions may have less than about 5 wt. %, less than about 4 wt. %, less than about 3 wt. %, less than about 2 wt. %, less than about 1 wt. %, less than about 0.5 wt. %, or less than about 0.1 wt. %, based on the total weight of the fabric composition, of acid. The fabric composition may be substantially free or free of acid in some embodiments. In at least one embodiment, the amount of acid present in the fabric composition is about 0 wt. % or 0 wt. % of an acid, based on the total weight of the fabric composition. In some cases, the fabric composition may have less than about 5 wt. %, less than about 4 wt. %, less than about 3 wt. %, less than about 2 wt. %, less than about 1 wt. %, less than about 0.5 wt. %, less than about 0.1 wt. %, about 0 wt. %, or 0 wt. % of a non-incidental amount of acid, based on the total weight of the fabric composition.

The fabric compositions may have a disintegration time that can vary depending on the formulation and form of the fabric composition. The disintegration time of fabric composition in the form of a tablet can be determined using a Disintegration Tester USP with a modified one-tube basket, where the fabric composition tablet is placed. The Disintegration Tester USP operates by moving the basket upwards and downwards vertically along its axis at a constant rate submerging the tablet in tap water that is maintained at a temperature of 20±5° C. The disintegration time may, thus, determined as the amount of time required for the fabric composition tablet to be completely disintegrated. In some embodiments, the fabric composition disintegrates from about 1 second to about 45 minutes. For example, the fabric compositions may be formulated and be in a form, such that the fabric composition disintegrates from about 1 second to about 45 minutes, from about 1 second to about 35 minutes, from about 1 second to about 25 minutes, from about 1 second to about 20 minutes, from about 1 second to about 15 minutes, from about 1 second to about 10 minutes, from about 1 second to about 5 minutes, from about 1 second to about 1 minute, from about 1 second to about 45 seconds, from about 1 second to about 30 seconds; from about 1 minute to about 45 minutes, from about 1 minute to about 35 minutes, from about 1 minute to about 25 minutes, from about 1 minute to about 20 minutes, from about 1 minute to about 15 minutes, from about 1 minute to about 10 minutes, from about 1 minute to about 5 minutes; from about 10 minutes to about 45 minutes, from about 10 minutes to about 35 minutes, from about 10 minutes to about 25 minutes, from about 10 minutes to about 20 minutes, from about 10 minutes to about 15 minutes; from about 15 minutes to about 45 minutes, from about 15 minutes to about 35 minutes, from about 15 minutes to about 25 minutes, from about 15 minutes to about 20 minutes; from about 25 minutes to about 35 minutes, or any range or subrange thereof.

The fabric compositions may be adapted to be a fabric conditioner composition. Fabric conditioner compositions typically increase the softness of a fabric. For example, the fabric composition may be a fabric conditioner composition that lowers the displacement stress of a fabric after application of the fabric composition to the fabric (e.g., during drying of the fabric) as measured using a Wool-HandleMeter instrument. The Wool-HandleMeter instrument measures the displacement stress of the towel as an inverse measure of the softness, which means that a lower displacement stress corresponds to a higher softness value for the towel.

Suitable components, such as those listed below, may be included or excluded from the formulations for the fabric compositions depending on the specific combination of other components, the form of the fabric compositions, and/or the use of the formulation (e.g., where the fabric composition is a fabric conditioner composition and/or the fabric composition is adapted for use during drying of the fabric, e.g., during a dry cycle of a clothing dryer).

The fabric compositions disclosed herein comprise a softening agent in an amount that may vary, but typically ranges from about from about 20 to about 70 wt. %, based on the total weight of the fabric composition. For example, the total amount of softening agent(s) in the fabric composition may be from about 20 to about 65 wt. %, about 20 to about 60 wt. %, about 20 to about 57 wt. %, about 20 to about 54 wt. %, about 20 to about 51 wt. %, about 20 to about 49 wt. %, about 20 to about 47 wt. %, about 20 to about 45 wt. %, about 20 to about 43 wt. %, about 20 to about 41 wt. %, about 20 to about 39 wt. %; from about 25 to about 70 wt. %, about 25 to about 65 wt. %, about 25 to about 60 wt. %, about 25 to about 57 wt. %, about 25 to about 54 wt. %, about 25 to about 51 wt. %, about 25 to about 49 wt. %, about 25 to about 47 wt. %, about 25 to about 45 wt. %, about 25 to about 43 wt. %, about 25 to about 41 wt. %, about 25 to about 39 wt. %; from about 30 to about 70 wt. %, about 30 to about 65 wt. %, about 30 to about 60 wt. %, about 30 to about 57 wt. %, about 30 to about 54 wt. %, about 30 to about 51 wt. %, about 30 to about 49 wt. %, about 30 to about 47 wt. %, about 30 to about 45 wt. %, about 30 to about 43 wt. %, about 30 to about 41 wt. %, about 30 to about 39 wt. %; from about 33 to about 70 wt. %, about 33 to about 65 wt. %, about 33 to about 60 wt. %, about 33 to about 57 wt. %, about 33 to about 54 wt. %, about 33 to about 51 wt. %, about 33 to about 49 wt. %, about 33 to about 47 wt. %, about 33 to about 45 wt. %, about 33 to about 43 wt. %, about 33 to about 41 wt. %, about 33 to about 39 wt. %; from about 36 to about 70 wt. %, about 36 to about 65 wt. %, about 36 to about 60 wt. %, about 36 to about 57 wt. %, about 36 to about 54 wt. %, about 36 to about 51 wt. %, about 36 to about 49 wt. %, about 36 to about 47 wt. %, about 36 to about 45 wt. %, about 36 to about 43 wt. %, about 36 to about 41 wt. %; from about 39 to about 70 wt. %, about 39 to about 65 wt. %, about 39 to about 60 wt. %, about 39 to about 57 wt. %, about 39 to about 54 wt. %, about 39 to about 51 wt. %, about 39 to about 49 wt. %, about 39 to about 47 wt. %, about 39 to about 45 wt. %, about 39 to about 43 wt. %; from about 41 to about 70 wt. %, about 41 to about 65 wt. %, about 41 to about 60 wt. %, about 41 to about 57 wt. %, about 41 to about 54 wt. %, about 41 to about 51 wt. %, about 41 to about 49 wt. %, about 41 to about 47 wt. %, about 41 to about 45 wt. %, about 41 to about 43 wt. %; from about 43 to about 70 wt. %, about 43 to about 65 wt. %, about 43 to about 60 wt. %, about 43 to about 57 wt. %, about 43 to about 54 wt. %, about 43 to about 51 wt. %, about 43 to about 49 wt. %, about 43 to about 47 wt. %, or any ranges and subranges thereof, based on the total weight of the fabric composition.

The softening agent of the fabric composition typically comprises at least one softening agent, which may comprise or consisting of one or more clay(s). The clays may be selected from smectite clays, such as montmorillonites, hectorites, bentonites, beidellites, saponites, vermiculites, stevensite, chlorites, and combinations of two or more thereof. For example, the softening agent may comprise kaolinite, smectite, bentonite, montmorillonite, and a combination of two or more thereof. The softening agent may comprise smectite, bentonite, or a combination thereof in some embodiments. Preferably, the clay comprises bentonite.

In some embodiments, the softening agent consists essentially of or consists of one or more clay(s). For instance, the one or more clays may be the only softening agent(s) in the fabric composition. The clay(s) may be comprised of about 50 wt. % or more of bentonite. In some instances, the bentonite may comprise about 55 wt. % or more, about 60 wt. % or more, about 65 wt. % or more, about 70 wt. % or more, about 75 wt. % or more, about 80 wt. % or more, about 85 wt. % or more, about 90 wt. % or more, about 95 wt. % or more, about 98 wt. % or more of the total amount of softening agent. In at least one embodiment, the softening agent consists essentially of or consists of bentonite.

The fabric composition comprises one or more filler(s) typically in an amount from about 25 to about 70 wt. %, based on the total weight of the fabric conditioner composition. For example, the total amount of filler(s) in the fabric composition may be from about 25 to about 65 wt. %, about 25 to about 60 wt. %, about 25 to about 57 wt. %, about 25 to about 54 wt. %, about 25 to about 51 wt. %, about 25 to about 49 wt. %, about 25 to about 47 wt. %, about 25 to about 45 wt. %, about 25 to about 43 wt. %; from about 30 to about 70 wt. %, about 30 to about 65 wt. %, about 30 to about 60 wt. %, about 30 to about 57 wt. %, about 30 to about 54 wt. %, about 30 to about 51 wt. %, about 30 to about 49 wt. %, about 30 to about 47 wt. %, about 30 to about 45 wt. %, about 30 to about 43 wt. %; from about 33 to about 70 wt. %, about 33 to about 65 wt. %, about 33 to about 60 wt. %, about 33 to about 57 wt. %, about 33 to about 54 wt. %, about 33 to about 51 wt. %, about 33 to about 49 wt. %, about 33 to about 47 wt. %, about 33 to about 45 wt. %, about 33 to about 43 wt. %; from about 36 to about 70 wt. %, about 36 to about 65 wt. %, about 36 to about 60 wt. %, about 36 to about 57 wt. %, about 36 to about 54 wt. %, about 36 to about 51 wt. %, about 36 to about 49 wt. %, about 36 to about 47 wt. %, about 36 to about 45 wt. %, about 36 to about 43 wt. %; from about 39 to about 70 wt. %, about 39 to about 65 wt. %, about 39 to about 60 wt. %, about 39 to about 57 wt. %, about 39 to about 54 wt. %, about 39 to about 51 wt. %, about 39 to about 49 wt. %, about 39 to about 47 wt. %, about 39 to about 45 wt. %, about 39 to about 43 wt. %; from about 41 to about 70 wt. %, about 41 to about 65 wt. %, about 41 to about 60 wt. %, about 41 to about 57 wt. %, about 41 to about 54 wt. %, about 41 to about 51 wt. %, about 41 to about 49 wt. %, about 41 to about 47 wt. %, about 41 to about 45 wt. %, about 41 to about 43 wt. %; from about 43 to about 70 wt. %, about 43 to about 65 wt. %, about 43 to about 60 wt. %, about 43 to about 57 wt. %, about 43 to about 54 wt. %, about 43 to about 51 wt. %, about 43 to about 49 wt. %, about 43 to about 47 wt. %, or any ranges and subranges thereof, based on the total weight of the fabric composition.

The one or more filler(s) of the fabric composition comprise a metal sulfate, a metal carbonate, and a combination of two or more thereof. The metal sulfate and/or metal carbonate may be selected from those having an alkali metal or an alkaline earth metal. For example, the metal carbonate(s) may be carbonates and/or bicarbonates having a metal ion that is an alkali metal or an alkaline earth metal. Examples of metal carbonates, which may be incorporated or in some instances excluded from the fabric composition, include sodium carbonate, sodium bicarbonate, calcium carbonate, calcium monohydrogen carbonate, sodium hydrogen carbonate, potassium carbonate, potassium monohydrogen carbonate, magnesium carbonate, magnesium monohydrogen carbonate, and combinations of two or more thereof.

The filler(s) may, additionally or alternatively, comprise metal sulfates chosen from sulfate and/or bisulfates having an alkali metal or an alkaline earth metal. Non-limiting examples of metal sulfates include sodium sulfate, sodium bisulfate, potassium sulfate, potassium bisulfate, magnesium sulfate, calcium sulfate, magnesium bisulfate, calcium bisulfate, and combinations of two or more thereof.

The fabric composition may include two or more fillers, e.g., three or more, four or more, five or more, six or more, seven or more, eight or more, or nine or more fillers. The fabric composition may include at least one filler selected from metal sulfates and at least one filler selected from metal carbonates. The fabric composition may include a metal sulfate in an amount from about 8 to about 24 wt. % and a metal carbonate in an amount from about 8 to about 24 wt. %, where the weight percentages are based on the total weight of the fabric composition. For example, the metal sulfate(s) may be present in the fabric composition in an amount from about 8 to about 24 wt. %, about 8 to about 22 wt. %, about 8 to about 20 wt. %, about 8 to about 18 wt. %, about 8 to about 16 wt. %, about 8 to about 14 wt. %; from about 10 to about 24 wt. %, about 10 to about 22 wt. %, about 10 to about 20 wt. %, about 10 to about 18 wt. %, about 10 to about 16 wt. %, about 10 to about 14 wt. %; from about 12 to about 24 wt. %, about 12 to about 22 wt. %, about 12 to about 20 wt. %, about 12 to about 18 wt. %, about 12 to about 16 wt. %, about 12 to about 14 wt. %; from about 14 to about 24 wt. %, about 14 to about 22 wt. %, about 14 to about 20 wt. %, about 14 to about 18 wt. %, about 14 to about 16 wt. %; from about 16 to about 24 wt. %, about 16 to about 22 wt. %, about 16 to about 20 wt. %, about 16 to about 18 wt. %, or any range or subrange thereof, based on the total weight of the fabric composition. Additionally or alternatively, the fabric composition may comprise metal carbonate(s) in an amount from about 8 to about 24 wt. %, about 8 to about 22 wt. %, about 8 to about 20 wt. %, about 8 to about 18 wt. %, about 8 to about 16 wt. %, about 8 to about 14 wt. %; from about 10 to about 24 wt. %, about 10 to about 22 wt. %, about 10 to about 20 wt. %, about 10 to about 18 wt. %, about 10 to about 16 wt. %, about 10 to about 14 wt. %; from about 12 to about 24 wt. %, about 12 to about 22 wt. %, about 12 to about 20 wt. %, about 12 to about 18 wt. %, about 12 to about 16 wt. %, about 12 to about 14 wt. %; from about 14 to about 24 wt. %, about 14 to about 22 wt. %, about 14 to about 20 wt. %, about 14 to about 18 wt. %, about 14 to about 16 wt. %; from about 16 to about 24 wt. %, about 16 to about 22 wt. %, about 16 to about 20 wt. %, about 16 to about 18 wt. %, or any range or subrange thereof, based on the total weight of the fabric composition.

In some embodiments, the filler comprises sodium sulfate, sodium carbonate, sodium bicarbonate, or a combination of two or more thereof. In at least one embodiment, the filler comprises sodium sulfate and sodium carbonate. For instance, in at least one preferred embodiment, the filler comprises sodium sulfate in an amount from about 8 to about 24 wt. %, based on the total weight of the fabric conditioner composition, and sodium carbonate in an amount from about 8 to about 24 wt. %, based on the total weight of the fabric composition.

The fabric composition may include, or in some cases exclude, one or more additional filler, e.g., fillers other than metal sulfates and metal carbonates. The additional fillers, which may be included or excluded from the fabric composition, may be metal alkali salts, such as sodium fluoride, sodium chloride, sodium bromide, sodium iodide, sodium phosphate, sodium monohydrogen phosphate, sodium dihydrogen phosphate, sodium acetate, sodium citrate, sodium lactate, sodium tartrate, sodium silicate, sodium ascorbate, potassium fluoride, potassium chloride, potassium bromide, potassium iodide, potassium phosphate, potassium monohydrogen phosphate, potassium dihydrogen phosphate, potassium acetate, potassium citrate, potassium lactate, potassium tartrate, potassium silicate, potassium, ascorbate, or combinations of two or more thereof. Examples of additional fillers selected from alkaline earth metals, which may be included or excluded from the fabric composition, include alkaline metal fluorides, alkaline metal chlorides, alkaline metal bromides, alkaline metal iodides, alkaline metal phosphates, alkaline metal monohydrogen phosphates, alkaline metal dihydrogen phosphates, alkaline metal acetates, alkaline metal citrates, alkaline metal lactates, alkaline metal pyruvates, alkaline metal silicates, alkaline metal ascorbates, or combinations of two or more thereof. Alkaline earth metal salts can be selected from magnesium fluoride, magnesium chloride, magnesium bromide, magnesium iodide, magnesium phosphate, magnesium monohydrogen phosphate, magnesium dihydrogen phosphate, magnesium acetate, magnesium citrate, magnesium lactate, magnesium tartrate, magnesium silicate, magnesium ascorbate, calcium fluoride, calcium chloride, calcium bromide, calcium iodide, calcium phosphate, calcium monohydrogen phosphate, calcium dihydrogen phosphate, calcium acetate, calcium citrate, calcium lactate, calcium tartrate, calcium silicate, calcium ascorbate, and a combination of two or more thereof.

The additional filler(s) (e.g., fillers other than metal sulfates and metal carbonates) may be present in an amount from about 6 to about 20 wt. %, based on the total weight of the fabric composition. For instance, the fabric composition may include additional filler(s) (e.g., fillers other than metal sulfates and metal carbonates) in an amount from about 6 to about 18 wt. %, about 6 to about 16 wt. %, about 6 to about 14 wt. %; from about 8 to about 20 wt. %, about 8 to about 18 wt. %, about 8 to about 16 wt. %, about 8 to about 14 wt. %; from about 10 to about 20 wt. %, about 10 to about 18 wt. %, about 10 to about 16 wt. %, about 10 to about 14 wt. %; from about 12 to about 20 wt. %, about 12 to about 18 wt. %, about 12 to about 16 wt. %, about 12 to about 14 wt. %; from about 14 to about 20 wt. %, about 14 to about 18 wt. %, about 14 to about 16 wt. %; from about 16 to about 20 wt. %, about 16 to about 18 wt. %, or any range or subrange thereof, based on the total weight of the fabric composition. In at least one embodiment, the additional filler(s) comprise sodium chloride, optionally, in an amount from about 6 to about 20 wt. %, based on the total weight of the fabric conditioner composition.

The fabric compositions may include one or more polyol(s). The amount of polyol(s) in the fabric composition may be from about 1 to about 15 wt. %, based on the total weight of the fabric composition. In some instances, the total amount of polyol(s) in the fabric compositions is from about 1 to about 15 wt. %, about 1 to about 13 wt. %, about 1 to about 11 wt. %, about 1 to about 9 wt. %, about 1 to about 8 wt. %, about 1 to about 7 wt. %, about 1 to about 6 wt. %; from about 3 to about 15 wt. %, about 3 to about 13 wt. %, about 3 to about 11 wt. %, about 3 to about 9 wt. %, about 3 to about 8 wt. %, about 3 to about 7 wt. %, about 3 to about 6 wt. %; from about 5 to about 15 wt. %, about 5 to about 13 wt. %, about 5 to about 11 wt. %, about 5 to about 9 wt. %, about 5 to about 8 wt. %, about 5 to about 7 wt. %; from about 6 to about 15 wt. %, about 6 to about 13 wt. %, about 6 to about 11 wt. %, about 6 to about 9 wt. %, about 6 to about 8 wt. %, about 6 to about 7 wt. %; from about 7 to about 15 wt. %, about 7 to about 13 wt. %, about 7 to about 11 wt. %, about 7 to about 9 wt. %; from about 8 to about 15 wt. %, about 8 to about 13 wt. %, about 8 to about 11 wt. %, about 8 to about 9 wt. %, or any range or subrange thereof, based on the total weight of the fabric composition.

The polyol(s) may be selected from glycols, glycerin, organic compound containing 4 or more, 5 or more, 6 or more, 7 or more, 8 or more, 10 or more, 20 or more, 50 or more, 100 or more, or 500 or more hydroxyl groups. For example, the polyol may comprise polyethylene glycols, polypropylene glycols, block copolymers comprising polyethylene groups and polypropylene glycols, or combinations of two or more thereof. In one embodiment, the polyol comprises a PEGylated glycol. The fabric composition may have at least one polyol having a molecular weight of 1,000 grams/mole (g/mole) or more. For instance, the polyol may have a molecular weight of about 1,500 g/mole or more, about 1,750 g/mole or more, about 2,000 g/mole or more, about 2,250 g/mole or more, about 2,500 g/mole or more, about 2,750 g/mole or more, about 3,000 g/mole or more, about 3,250 g/mole or more, about 3,500 g/mole or more, about 3,750 g/mole or more, about 4,000 g/mole or more, about 4,200 g/mole or more, about 4,400 g/mole or more, about 4,600 g/mole or more, about 4,800 g/mole or more, about 5,000 g/mole or more, about 5,500 g/mole or more, about 6,000 g/mole or more, about 6,500 g/mole or more, about 7,000 g/mole or more, about 7,500 g/mole or more, or any range or subrange thereof. Additionally or alternatively, the polyol may have a molecular weight of up to about 10,000 g/mole, up to about 9,000 g/mole, up to about 8,000 g/mole, up to about 7,000 g/mole, up to about 6,000 g/mole, up to about 5,000 g/mole, or up to about 4,500 g/mole. In some embodiments, the polyol comprises a polyethylene glycol, a polypropylene glycol, and/or a block copolymer comprising polyethylene groups and polypropylene glycols having a molecular weight according to a range formed from any of the foregoing listed molecular weights for the polyol(s), such as from about 1,500 g/mole or more and up to about 10,000 g/mole, from about 2,000 g/mole up to about 8,000 g/mole, or from about 3,000 g/mole up to about 7,000 g/mole. The polyol may have a melting point temperature of 50° C. or more, e.g., about 60° C. or more, about 70° C. or more, or about 85° C. or more.

The fabric composition includes at least one lubricant. The lubricant(s) may be present in the fabric composition in an amount up to about 5 wt. %, based on the total weight of the fabric compositions. For example, the total amount of lubricant(s) in the fabric composition may be an amount up to about 5 wt. %, an amount up to about 4 wt. %, an amount up to about 3 wt. %, an amount up to about 2 wt. %, an amount up to about 1.5 wt. %, an amount up to about 1 wt. %, an amount up to about 0.5 wt. %; from about 0.05 to about 5 wt. %, about 0.05 to about 4 wt. %, about 0.05 to about 3 wt. %, about 0.05 to about 2 wt. %, about 0.05 to about 1.5 wt. %, about 0.05 to about 1 wt. %, about 0.05 to about 0.5 wt. %, about 0.05 to about 0.3 wt. %, about 0.05 to about 0.2 wt. %, about 0.05 to about 0.1 wt. %; from about 0.1 to about 5 wt. %, about 0.1 to about 4 wt. %, about 0.1 to about 3 wt. %, about 0.1 to about 2 wt. %, about 0.1 to about 1.5 wt. %, about 0.1 to about 1 wt. %, about 0.1 to about 0.5 wt. %, about 0.1 to about 0.3 wt. %; from about 0.5 to about 5 wt. %, about 0.5 to about 4 wt. %, about 0.5 to about 3 wt. %, about 0.5 to about 2 wt. %, about 0.5 to about 1.5 wt. %, about 0.5 to about 1 wt. %; from about 1 to about 5 wt. %, about 1 to about 4 wt. %, about 1 to about 3 wt. %, about 1 to about 2 wt. %, about 1 to about 1.5 wt. %; from about 1.5 to about 5 wt. %, about 1.5 to about 4 wt. %, about 1.5 to about 3 wt. %, about 1.5 to about 2 wt. %, from about 2.5 to about 5 wt. %, about 2.5 to about 4 wt. %, about 2.5 to about 3 wt. %; from about 3.5 to about 5 wt. %, about 3.5 to about 4 wt. %, or any range or subrange thereof, based on the total weight of the fabric composition.

The fabric composition may include one or more lubricant that is adapted to improve flowability of the fabric composition when in a powder form. The lubricant may reduce the coefficient of friction between the fibers and yarns in articles receiving the fabric composition, both during and after the drying process.

The lubricant may be a starch, a modified starch (including, but not limited to, corn starch, potato starch, or hydroxyl ethyl starch), a silica, a siloxane, calcium carbonate, magnesium carbonate, clay, talc, silicic acid, kaolin, gypsum, zeolite, cylclodextrin, calcium stearate, zinc stearate, alumina, magnesium stearate, alumina, zinc oxide, kaolin, stearic acid, sodium stearyl fumarate, or a combination of two or more thereof. In one embodiment, the lubricant is selected from starches, modified starches, silicas, siloxanes, calcium carbonate, magnesium carbonate, clay, talc, silicic acid, gypsum, zeolites, cylclodextrins, calcium stearate, zinc stearate, alumina, magnesium stearate, alumina, zinc oxide, kaolin, stearic acid, sodium stearyl fumarate, and a combination of two or more thereof.

The lubricant may be in the form of a powder in some cases. For example, the lubricant may be a powder having an average particle size of at least about 0.1 μm or in a range of about 0.1 μm to about 100 μm.

The lubricant may include or, in some instances, exclude a fiber lubricant, such as those described herein. Fiber lubricants enhance the conditioning, softening, wrinkle-reduction and protective effects of the fabric composition. As used herein “fiber lubricants” refers to non-cationic materials intended to lubricate fibers for the purpose of reducing the friction between fibers or yarns in an article comprising textiles that provides one or more of wrinkle-reduction, fabric conditioning, and/or protective benefit.

Examples of fiber lubricants include oily sugar derivatives, functionalized plant and animal-derived oils, silicones, mineral oils, natural, synthetic waxes, and triglycerides. Such ingredients often have low HLB values, less than about 10, although exceeding this level is not outside of the scope of this invention. Non-limiting examples of plant derived triglyceride materials include hydrophilically modified triglyceride oils, e.g. sulfated, sulfonated, carboxylated, alkoxylated, esterified, saccharide modified, and amide derivatized oils, tall oils and derivatives thereof. Examples of animal derived triglyceride materials include hydrophilically modified fish oil, tallow, lard, and lanolin wax.

The fabric compositions may include one or more glidant(s). The glidant(s) may be present in the fabric composition in an amount up to about 5 wt. %, based on the total weight of the fabric compositions. For example, the total amount of glidant(s) in the fabric composition may be an amount up to about 5 wt. %, an amount up to about 4 wt. %, an amount up to about 3 wt. %, an amount up to about 2 wt. %, an amount up to about 1.5 wt. %, an amount up to about 1 wt. %, an amount up to about 0.5 wt. %; from about 0.05 to about 5 wt. %, about 0.05 to about 4 wt. %, about 0.05 to about 3 wt. %, about 0.05 to about 2 wt. %, about 0.05 to about 1.5 wt. %, about 0.05 to about 1 wt. %, about 0.05 to about 0.5 wt. %, about 0.05 to about 0.3 wt. %, about 0.05 to about 0.2 wt. %, about 0.05 to about 0.1 wt. %; from about 0.1 to about 5 wt. %, about 0.1 to about 4 wt. %, about 0.1 to about 3 wt. %, about 0.1 to about 2 wt. %, about 0.1 to about 1.5 wt. %, about 0.1 to about 1 wt. %, about 0.1 to about 0.5 wt. %, about 0.1 to about 0.3 wt. %; from about 0.5 to about 5 wt. %, about 0.5 to about 4 wt. %, about 0.5 to about 3 wt. %, about 0.5 to about 2 wt. %, about 0.5 to about 1.5 wt. %, about 0.5 to about 1 wt. %; from about 1 to about 5 wt. %, about 1 to about 4 wt. %, about 1 to about 3 wt. %, about 1 to about 2 wt. %, about 1 to about 1.5 wt. %; from about 1.5 to about 5 wt. %, about 1.5 to about 4 wt. %, about 1.5 to about 3 wt. %, about 1.5 to about 2 wt. %, from about 2.5 to about 5 wt. %, about 2.5 to about 4 wt. %, about 2.5 to about 3 wt. %; from about 3.5 to about 5 wt. %, about 3.5 to about 4 wt. %, or any range or subrange thereof, based on the total weight of the fabric composition.

Examples of glidants, which may be included or excluded from the fabric composition, include colloidal silicon dioxide, stearic acid, magnesium stearate, calcium stearate, talc, hydrogenated castor oil, sucrose esters of fatty acid, microcrystalline wax, yellow beeswax, white beeswax, metal silicate, glyceryl behenate, sodium benzoate, sodium stearyl fumarate, starch, or a combination of two or more thereof. The glidant may be metal silicate, such as alkali metal silicates and/or alkaline earth metal silicates. Preferably, the metal silicate is selected from sodium silicate, potassium silicate, and a combination thereof. Additionally or alternatively, the glidant(s) may be chosen from glyceryl behenate, sodium benzoate, sodium stearyl fumarate, starch, and a combination of two or more thereof.

The fabric composition may include one or more oil in an amount that may vary, but typically in an amount from about 0.1 to about 8 wt. %, based on the total weight of the fabric composition. For example, the oil may be present in the fabric composition in an amount from about 0.1 to about 6 wt. %, about 0.1 to about 4 wt. %, about 0.1 to about 3 wt. %, about 0.1 to about 2 wt. %, about 0.1 to about 1 wt. %; from about 0.3 to about 8 wt. %, about 0.3 to about 6 wt. %, about 0.3 to about 4 wt. %, about 0.3 to about 3 wt. %, about 0.3 to about 2 wt. %, about 0.3 to about 1 wt. %; from about 0.5 to about 8 wt. %, about 0.5 to about 6 wt. %, about 0.5 to about 4 wt. %, about 0.5 to about 3 wt. %, about 0.5 to about 2 wt. %, about 0.5 to about 1 wt. %; from about 0.8 to about 8 wt. %, about 0.8 to about 6 wt. %, about 0.8 to about 4 wt. %, about 0.8 to about 3 wt. %, about 0.8 to about 2 wt. %, about 0.8 to about 1 wt. %, or any range and subrange thereof, based on the total weight of the fabric composition.

The fabric composition may include oil(s), including hydrocarbon oils and plant-based oils. The oil may be volatile or non-volatile, linear or branched hydrocarbons, of mineral or synthetic origin, and derivatives thereof. For example, the oil may be a mineral or synthetic oil, such as linear or branched alkanes. The linear or branched alkanes may have from 8 to 18 carbon atoms. Non-limiting examples of linear alkanes that are suitable for use in the fabric composition include n-heptane (C₇), n-octane (C₈), n-nonane (C₉), n-decane (C₁₀), n-undecane (C₁₁), n-dodecane (C₁₂), n-tridecane (C₁₃) and n-tetradecane (C₁₄), and mixtures thereof. In one embodiment, the oil is a mineral oil.

The oil may be an ester oil or ether oil. Examples of synthetic ester oils and ether oils include those of fatty acids and/or of fatty alcohols, such as the oils of formulae R¹COOR² and R¹OR² in which R¹ represents a fatty acid residue containing from 7 to 29 carbon atoms and R 2 represents a branched or unbranched hydrocarbon-based chain containing from 3 to 30 carbon atoms. For example, the synthetic esters and ethers oils may be chosen from purcellin oil, isononyl isononanoate, isopropyl myristate, isopropyl palmitate, 2-ethylhexyl palmitate, 2-octyldodecyl stearate, isocetyl stearate, 2-octyldodecyl erucate, isostearyl isostearate, and a combination of two or more thereof. The esters may, additionally or alternatively, be selected from hydroxylated esters, such as isostearyl lactate, octyl hydroxystearate, octyldodecyl hydroxystearate, diisostearyl malate, triisocetyl citrate; fatty alkyl heptanoates, octanoates and/or decanoates; polyol esters, such as propylene glycol dioctanoate, neopentyl glycol diheptanoate and diethylene glycol diisononanoate; and pentaerythritol esters, such as pentaerythrityl tetraisostearate.

The oil may be a plant-based oil selected from hydrocarbon-based oils of plant origin, liquid triglycerides of fatty acids comprising from 4 to 10 carbon atoms, such as heptanoic or octanoic acid triglycerides, fatty ester oils, and fatty ether oils. Non-limiting examples of liquid triglycerides and oils of plant origin include alexandria laurel tree oil, avocado oil, apricot stone oil, barley oil, borage seed oil, calendula oil, canelle nut tree oil, canola oil, caprylic/capric triglyceride castor oil, coconut oil, corn oil, cotton oil, cottonseed oil, evening primrose oil, flaxseed oil, groundnut oil, hazelnut oil, glycereth triacetate, glycerol triheptanoate, glyceryl trioctanoate, glyceryl triundecanoate, hempseed oil, jojoba oil, lucerne oil, maize germ oil, marrow oil, millet oil, neopentylglycol dicaprylate/dicaprate, olive oil, palm oil, passionflower oil, pentaerythrityl tetrastearate, poppy oil, propylene glycol ricinoleate, rapeseed oil, rye oil, safflower oil, sesame oil, shea butter, soya oil, soybean oil, sweet almond oil, sunflower oil, sysymbrium oil, syzigium aromaticum oil, tea tree oil, walnut oil, wheat germ glycerides wheat germ oil, and a combination of two or more thereof.

Natural oils that may be included or excluded in certain embodiments include natural oils of plant origin, such as amaranth seed oil, apricot kernel oil, argan oil, avocado oil, babassu oil, cottonseed oil, borage seed oil, camelina oil, thistle oil, peanut oil, pomegranate seed oil, grapefruit seed oil, hemp oil, hazelnut oil, elderberry seed oil, currant seed oil, jojoba oil, linseed oil, macadamia nut oil, corn oil, almond oil, marula oil, evening primrose oil, olive oil, palm oil, palm kernel oil, Brazil nut oil, pecan nut oil, peach kernel oil, rapeseed oil, castor oil, sea buckthorn pulp oil, sea buckthorn kernel oil, sesame oil, soy bean oil, sunflower oil, grapeseed oil, walnut oil, wild rose oil, wheat germ oil, the liquid components of coconut oil, or a combination of two or more thereof. In some embodiments, one or more of the oils disclosed in the present application may be excluded from the fabric composition.

The fabric composition may comprise water. Although the fabric composition may be in the form of a tablet and/or powder that has less than 5 wt. % of water, in some embodiments the fabric composition contains 5 wt. % or more of water. For example, the fabric composition may comprise from about 6 to about 20 wt. % of water, based on the total weight of the fabric composition. In some embodiments, the amount of water present in the fabric composition is from about 6 to about 18 wt. %, about 6 to about 16 wt. %, about 6 to about 14 wt. %; from about 8 to about 20 wt. %, about 8 to about 18 wt. %, about 8 to about 16 wt. %, about 8 to about 14 wt. %; from about 10 to about 20 wt. %, about 10 to about 18 wt. %, about 10 to about 16 wt. %, about 10 to about 14 wt. %; from about 12 to about 20 wt. %, about 12 to about 18 wt. %, about 12 to about 16 wt. %, about 12 to about 14 wt. %; from about 14 to about 20 wt. %, about 14 to about 18 wt. %, about 14 to about 16 wt. %; from about 16 to about 20 wt. %, about 16 to about 18 wt. %, or any range or subrange thereof, based on the total weight of the fabric composition.

In accordance with another aspect, provided is a method applying a fabric composition. The method, according to certain embodiments, may improve or enhance certain characteristics of the fabric receiving the fabric composition including, e.g., the softness, the fragrance, and/or the appearance of the fabric.

The process of laundering fabric can be broken up into three basic steps: washing, rinsing, and drying. The washing step typically employs water and detergent composition comprising anionic surfactant, along with other active agents that are compatible with anionic surfactants in the unused product form and in the wash liquor formed during the washing step. After washing, the laundry is rinsed one or more times as part of the rinsing step.

The drying step typically occurs after the washing of the laundry. In some embodiments, the method includes applying the fabric composition during the drying step. The application of the fabric composition may occur due to the heat and/or physical impacts to the fabric composition during the drying step, such as tumbling in a clothing dryer. Accordingly, although the fabric composition may be positioned in the dryer before the drying step, the fabric composition may be applied only after the drying step starts.

In some embodiments, the application of the fabric composition includes heating the fabric composition at a temperature of about 100° F. or more, about 110° F. or more, about 120° F. or more, about 125° F. or more, about 130° F. or more, about 135° F. or more, about 140° F. or more, about 145° F. or more, or about 150° F. or more. In some instances, the application of the fabric includes heating the fabric composition at one of the above listed temperatures for at least 1 second, about 30 or more seconds, about 60 or more seconds, about 5 minutes or more, about 15 minutes or more, or about 25 minutes or more.

Non-limiting embodiments of certain aspects of the invention are discussed below to elucidate various combinations of features according to the disclosure herein. Additional combinations of features for embodiments of the invention are contemplated by inventors.

In accordance with embodiment 1, provided is a fabric conditioner comprising:
from about 20 to about 70 wt. %, based on the total weight of the fabric conditioner composition, of a softening agent comprising a clay;
from about 25 to about 70 wt. %, based on the total weight of the fabric conditioner composition, of a filler selected from a metal sulfate, a metal carbonate, and a combination of two or more thereof; and
from about 1 to about 15 wt. %, based on the total weight of the fabric conditioner composition, of a polyol,
   wherein the fabric conditioner composition has less than about 1 wt. % of quaternary ammonium compounds.

According to embodiment 2, the fabric conditioner composition according to embodiment 1, wherein the clay comprises bentonite.

According to embodiment 3, the fabric conditioner composition according to embodiment 2, wherein the bentonite comprises about 55 wt. % or more of the total amount of the softening agent, based on the total weight of the softening agent.

According to embodiment 4, the fabric conditioner composition according to embodiment 2 or embodiment 3, wherein the bentonite comprises about 90 wt. % or more of the total amount of the softening agent, based on the total weight of the softening agent.

According to embodiment 5, the fabric conditioner composition according to any of embodiment 2 to embodiment 4, wherein the bentonite comprises about 99 wt. % or more of the total amount of the softening agent, based on the total weight of the softening agent.

According to embodiment 6, the fabric conditioner composition according to any foregoing embodiment, wherein the filler comprises sodium sulfate, sodium carbonate, sodium bicarbonate, or a combination of two or more thereof.

According to embodiment 7, the fabric conditioner composition according to any foregoing embodiment, wherein the filler comprises sodium sulfate in an amount from about 8 to about 24 wt. %, based on the total weight of the fabric conditioner composition, and sodium carbonate in an amount from about 8 to about 24 wt. %, based on the total weight of the fabric conditioner composition.

According to embodiment 8, the fabric conditioner composition according to any foregoing embodiment, wherein the filler further comprises sodium chloride, optionally, in an amount from about 6 to about 20 wt. %, based on the total weight of the fabric conditioner composition.

According to embodiment 9, the fabric conditioner composition according to any foregoing embodiment further comprising:
an oil, optionally, in an amount from about 0.1 to about 8 wt. %, based on the total weight of the fabric conditioner composition.

According to embodiment 10, the fabric conditioner compositions according to embodiment 9, wherein the oil comprises a hydrocarbon oil, preferably mineral oil.

According to embodiment 11, the fabric conditioner compositions according to embodiment 9 or embodiment 10, wherein the oil comprises a plant-based oil.

According to embodiment 12, the fabric conditioner composition according to any foregoing embodiment, wherein the polyol has a melting point temperature of 50° C. or more.

According to embodiment 13, the fabric conditioner composition according to any foregoing embodiment, wherein the polyol comprises a glycol.

According to embodiment 14, the fabric conditioner composition according to embodiment 12 or embodiment 13, wherein the polyol comprises polyethylene glycols, polypropylene glycols, block copolymers comprising polyethylene groups and polypropylene glycols or a combination of two or more thereof, wherein the polyol has a molecular weight from about 1,600 to about 10,000 grams/mole.

According to embodiment 15, the fabric conditioner composition according to any foregoing embodiment further comprising:
a lubricant, optionally, in an amount up to about 5 wt. %, based on the total weight of the fabric conditioner composition.

According to embodiment 16, the fabric conditioner composition according to embodiment 15, wherein the lubricant comprises magnesium stearate.

According to embodiment 17, the fabric conditioner composition according to any foregoing embodiment further comprising:
a glidant, optionally, in an amount up to about 5 wt. %, based on the total weight of the fabric conditioner composition.

According to embodiment 18, the fabric conditioner composition according to embodiment 17, wherein the glidant is a metal silicate.

According to embodiment 19, the fabric conditioner composition according to any foregoing embodiment, wherein the fabric conditioner composition is substantially free or free of quaternary ammonium compounds.

According to embodiment 20, the fabric conditioner composition according to any foregoing embodiment, wherein the fabric conditioner has less than about 3 wt. % of an acid, based on the total weight of the fabric conditioner.

According to embodiment 21, the fabric conditioner composition according to any foregoing embodiment, wherein the fabric conditioner composition is substantially free or free of an acid.

According to embodiment 22, the fabric conditioner composition according to any foregoing embodiment, wherein the fabric conditioner composition has less than about 3 wt. % of water, based on the total weight of the fabric conditioner.

According to embodiment 23, the fabric conditioner composition according to any foregoing embodiment, wherein the fabric conditioner composition is substantially free or free of water.

According to embodiment 24, the fabric conditioner composition according to any foregoing embodiment, wherein the fabric conditioner composition is in the form of a tablet.

According to embodiment 25, the fabric conditioner composition according to any foregoing embodiment, wherein the conditioner composition has a disintegration time of 20 minutes or less.

In accordance with an embodiment 26, provided a fabric conditioner tablet comprising:
from about 20 to about 70 wt. %, based on the total weight of the fabric conditioner tablet, of bentonite;
a filler selected from a metal sulfate, a metal carbonate, and a combination of two or more thereof; and
from about 1 to about 15 wt. %, based on the total weight of the fabric conditioner tablet, of a polyol,

wherein the fabric conditioner tablet comprises less than about 3 wt. % of water, based on the total weight of the fabric conditioner tablet.

In accordance with an embodiment 27, provided is a fabric conditioner composition comprising:
from about 20 to about 70 wt. %, based on the total weight of the fabric conditioner composition, of bentonite;
a filler selected from a metal sulfate, a metal carbonate, and a combination of two or more thereof; and
from about 1 to about 15 wt. %, based on the total weight of the fabric conditioner composition, of a polyol,

wherein the fabric conditioner composition is free of softening agents other than bentonite.

### EXAMPLES

### Example 1

A non-limiting exemplary fabric conditioner composition (Example Composition A) was prepared in accordance with aspects of the invention. Example Composition A was in the form of a tablet and had the formulation shown in Table 1.

TABLE 1

| | Example |
|---|---|
| INCI Compound Name | Composition A (wt. %) |
| Bentonite | 42.7 |
| Sodium Sulfate | 16.7 |
| Sodium Carbonate | 17.6 |
| Sodium Chloride | 11.1 to 14.6 |
| Mineral Oil | 0.5 |
| PEG 4000 | 7.6 |
| Sodium Silicate | 0.1 |
| Magnesium Stearate | 0.15 to 0.2 |
| Powder Colorant | 0 to 0.04 |
| Fragrance Oil | 0 to 3 |

### Example 2

The fragrance of Example Composition A was evaluated in comparison to a commercial benchmark fabric conditioner (Comparative Composition 1). Comparative Composition 1 was in a liquid form and had the formulation provided in Table 2.

TABLE 2

| | Comparative |
|---|---|
| INCI Compound Name | Composition 1 (wt. %) |
| Water | 92 |
| Dialkyl Ester of Triethanol | 6.7 |
| Ammonium Methyl Sulphate | |
| Lactic Acid | 0.08 |
| Etidronic Acid | 0.06 |
| Cationic Acrylate Thickener | 0.2 |
| Colorant | 0.002 |
| Fragrance Oil & Capsule | 1 |
| Polyquaternium 7 Modified | 0.3 |

Example Composition A and Comparative Composition 1 were added to separate washes of cotton towels and then evaluated to assess the fragrance of the towels after the wash. Specifically, a laundry load of 2.5 kg of 100% cotton towels was washed by adding a conventional liquid fabric detergent and Example Composition A at the start of the laundry wash. A second laundry load of 2.5 kg of 100% cotton towels was washed by adding the same conventional liquid fabric detergent at the start of the laundry wash and adding Comparative Composition 1 during the rinse cycle of the wash.

After the laundry cycle finished, a sample of wet towels was evaluated by fragrance experts and the rest were dried in a tumble dryer and in line (e.g., hanging indoors and drying under ambient conditions). After the towels dried, the fragrance experts evaluated the sample of dried towels. It was determined that Example Composition A delivered a similar fragrance intensity as Comparative Composition 1.

### Example 3

The softness of towels after washing with Example Composition A or Comparative Composition 1 was evaluated. Specifically, two standardized cotton towels were washed according to the procedure described in Example 2, except that the two cotton towels were only dried in line. After drying, each towel was cut into the circles of 15 cm diameter, placed on a clean tray and stored in a climate control chamber at a temperature of 25° C. and relative humidity of 60% for 24 hours. After the 24 hours, the weight and the thickness of the towel pieces were measured and then analyzed one-by-one with a Wool-HandleMeter instrument. The Wool-HandleMeter instrument measures the displacement stress of the towel as an inverse measure of the softness, which means that a lower displacement stress corresponds to a higher softness value for the towel.

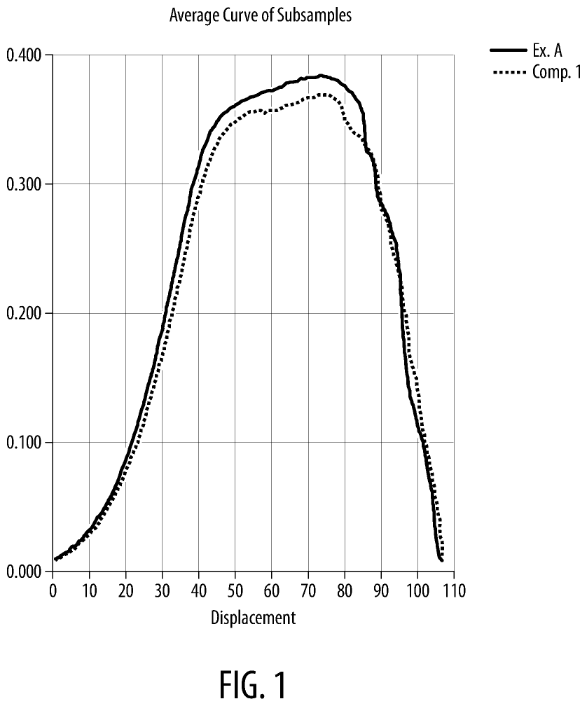

As seen in FIG. 1, Example Composition A and Comparative Composition 1 had similar softness measurements, therefore demonstrating the capacity of Example Composition A to provide ample softness.

1. A fabric conditioner composition comprising:
from about 20 to about 70 wt. %, based on the total weight of the fabric conditioner composition, of a softening agent comprising a clay;
from about 25 to about 70 wt. %, based on the total weight of the fabric conditioner composition, of a filler selected from a metal sulfate, a metal carbonate, and a combination of two or more thereof; and
from about 1 to about 15 wt. %, based on the total weight of the fabric conditioner composition, of a polyol,
wherein the fabric conditioner composition has less than about 1 wt. %, based on the total weight of the fabric conditioner composition, of quaternary ammonium compounds.

2. The fabric conditioner composition according to claim 1, wherein the clay comprises bentonite.

3. The fabric conditioner composition according to claim 2, wherein the bentonite comprises about 55 wt. % or more of the total amount of the softening agent, based on the total weight of the softening agent.

4. The fabric conditioner composition according to claim 2, wherein the bentonite comprises about 90 wt. % or more of the total amount of the softening agent, based on the total weight of the softening agent.

5. The fabric conditioner composition according to claim 2, wherein the bentonite comprises about 99 wt. % or more of the total amount of the softening agent, based on the total weight of the softening agent.

6. The fabric conditioner composition according to claim 1, wherein the filler comprises sodium sulfate, sodium carbonate, sodium bicarbonate, or a combination of two or more thereof.

7. The fabric conditioner composition according to claim 1, wherein the filler comprises sodium sulfate in an amount from about 8 to about 24 wt. %, based on the total weight of the fabric conditioner composition, and sodium carbonate in an amount from about 8 to about 24 wt. %, based on the total weight of the fabric conditioner composition.

8. The fabric conditioner composition according to claim 1, wherein the filler further comprises sodium chloride present in an amount from about 6 to about 20 wt. %, based on the total weight of the fabric conditioner composition.

9. The fabric conditioner composition according to claim 1 further comprising:
an oil present in an amount from about 0.1 to about 8 wt. %, based on the total weight of the fabric conditioner composition, wherein the oil comprises a mineral oil, a plant-based oil, or a combination thereof.

10-13. (canceled)

14. The fabric conditioner composition according to claim 1, wherein the polyol comprises polyethylene glycols, polypropylene glycols, block copolymers comprising polyethylene groups and polypropylene glycols or a combination of two or more thereof, wherein the polyol has a molecular weight from about 1,600 to about 10,000 grams/mole.

15. The fabric conditioner composition according to claim 1 further comprising:
a lubricant present in an amount up to about 5 wt. %, based on the total weight of the fabric conditioner composition.

16. The fabric conditioner composition according to claim 15, wherein the lubricant comprises magnesium stearate.

17. The fabric conditioner composition according to claim 1 further comprising:
a glidant present in an amount up to about 5 wt. %, based on the total weight of the fabric conditioner composition.

18. The fabric conditioner composition according to claim 17, wherein the glidant is a metal silicate.

19. The fabric conditioner composition according to claim 1, wherein the fabric conditioner composition is substantially free or free of quaternary ammonium compounds.

20. The fabric conditioner composition according to claim 1, wherein the fabric conditioner has less than about 3 wt. % of an acid, based on the total weight of the fabric conditioner.

21. (canceled)

22. The fabric conditioner composition according to claim 1, wherein the fabric conditioner composition has less than about 3 wt. % of water, based on the total weight of the fabric conditioner.

23-24. (canceled)

25. The fabric conditioner composition according to claim 1, wherein the conditioner composition has a disintegration time of 20 minutes or less.

26. (canceled)

27. A fabric conditioner composition comprising:
from about 20 to about 70 wt. %, based on the total weight of the fabric conditioner composition, of bentonite;
a filler selected from a metal sulfate, a metal carbonate, and a combination of two or more thereof; and
from about 1 to about 15 wt. %, based on the total weight of the fabric conditioner composition, of a polyol,
wherein the fabric conditioner composition is free of softening agents other than bentonite.

28. A method comprising increasing the softness of a fabric by applying a fabric conditioner composition according to claim 1 to the fabric during the drying of a fabric.

29. (canceled)
